(19) United States
(12) Patent Application Publication
(10) Pub. No.: US 2024/0135179 A1
(43) Pub. Date: Apr. 25, 2024

(54) ENHANCED TESTING OF PERSONALIZED SERVERS IN EDGE COMPUTING

(71) Applicant: Level 3 Communications, LLC, Broomfield, CO (US)

(72) Inventors: Bryan DREYER, Bellevue, WA (US); Brent SMITH, Arvada, CO (US); James SUTHERLAND, Ridgefield, WA (US)

(73) Assignee: Level 3 Communications, LLC, Broomfield, CO (US)

(21) Appl. No.: 18/489,791

(22) Filed: Oct. 17, 2023

Related U.S. Application Data
(60) Provisional application No. 63/380,135, filed on Oct. 19, 2022.

(51) Int. Cl. G06N 3/08

(52) U.S. Cl. CPC G06N 3/08

(57) ABSTRACT

This disclosure describes systems, methods, and devices related to testing servers provisioned in an edge computing device. An edge computing device may detect that a server has been provisioned to access a public network cloud using backbone routers of the edge computing device; provide a neural network for evaluating a probability that a performance of the server will satisfy performance criteria, the neural network trained based on training data comprising labeled settings data and feature weights; input settings and configurations associated with the provisioning of the server as inputs to the neural network; and generate, using the neural network, based on the inputs and the training data, a confidence score indicative of the probability.

### CROSS-REFERENCE TO RELATED APPLICATION

This application is related to and claims priority under 35 U.S.C. § 119(e) from U.S. Patent Application No. 63/380,135, filed Oct. 19, 2022, titled “ENHANCED TESTING OF PERSONALIZED SERVERS IN EDGE COMPUTING,” the entire content of which is incorporated herein by reference for all purposes.

### TECHNICAL FIELD

Embodiments of the present invention generally relate to systems and methods for network edge computing systems.

### BACKGROUND

When a customer premises device is provisioned at a customer location, the provisioning may include downloading software and configurations for the device, often from a centralized server using a file transfer protocol. The downloads and configuration may require a significant amount of time, and there may be some risk of data corruption during the download.

### SUMMARY

Users may provision and turn up personal servers in an edge computing environment to provide direct access to public resources, such as the Internet or other cloud resources. The provisioning of a server in an edge computing environment may allow the user to customize the settings and configurations of the server, allowing for user selections of settings, configurations, and operating systems.

Once a user has provisioned a server in an edge computing environment (e.g., a bare metal server-as-a-service), the edge computing environment may use artificial intelligence trained to determine the types of settings and configurations of the server to monitor, and the criteria with which to assess performance of the server. The artificial intelligence may, without requiring user selection of server data to analyze, identify subsets of all settings and configuration data of the server to analyze, set and adjust weights for the settings and configuration data being analyzed, and set and adjust criteria against which to compare the settings and configuration data for performance analysis. The artificial intelligence may be trained to generate a confidence score based on the settings and configuration data of a server provisioned using the edge computing environment. The confidence score may indicate a probability that the server will meet the performance criteria.

The artificial intelligence may detect drift in the settings, configurations, and/or performance of the server from expected baselines. The artificial intelligence may compare data from a server to data of another server/topology to detect a correlation (e.g., indicative of an expected drift or unexpected drift, and indicative of a root cause of the drift). When drift is unexpected or the cause is not identified, the edge computing environment may notify a user of the server. When the confidence score is below a score threshold, indicating that the server is performing or will perform poorly based on its settings and configurations, the edge computing environment may notify the user of the server.

### BRIEF DESCRIPTION OF THE DRAWINGS

FIG. 1 illustrates an exemplary network environment for edge computing in accordance with one embodiment.

FIG. 2 is a schematic diagram of artificial intelligence of FIG. 1 used to test servers used in edge computing in accordance with one embodiment.

FIG. 3 is a flowchart illustrating a process for testing servers used in edge computing in accordance with one embodiment.

FIG. 4 is a diagram illustrating an example of a computing system that may be used in implementing embodiments of the present disclosure.

### DETAILED DESCRIPTION

Aspects of the present disclosure involve systems, methods, and the like, for automating network edge computing collection and analysis of system data.

As the amount of data traveling between client devices and network clouds increases, edge computing may allow for improved scalability and efficiency for delivering data by bringing client devices to smaller cloud environments. Applications may reside at a customer premises edge in a distributed environment, providing a shorter, more direct path from client devices to the edge cloud than to a public cloud, latency and overall efficiency may be improved. To facilitate such edge computing, customer premises may use an edge gateway device that may deliver network routing and security services, data filtering, and hosting of applications, and connectivity between on-premises applications and the edge cloud. The edge cloud may provide compute and storage services, such as bare metal, network storage, and virtualized services (e.g., private cloud and virtual machines). Deploying bare metal servers at an edge cloud may be referred to as bare metal-as-a service.

The edge cloud may allow for bare metal servers with customized configurations to connect directly to the network backbone (e.g., directly connect to the Internet with no firewall needed). When a user adds a bare metal server, the user may be allowed to select settings and configurations to implement, but which may be undesirable for hardware and software.

Once a server has been running for a while in a network environment, some techniques allow for performance data ingestion and analysis to monitor server performance. Existing techniques selects certain performance data to monitor and tests that data. However, existing techniques exclude the analysis of certain performance data and require a selection of which data to monitor and not monitor. Improved performance monitoring by edge computing devices may not limit the server performance data to be monitored. However, when there may be thousands of files and settings to test, edge computing devices may not identify which data to monitor without being directed to analyze certain data and ignore other data.

In one or more embodiments, an edge computing device may monitor data of bare metal servers configured via an edge cloud as the servers are built (e.g., immediately upon building). By using trained artificial intelligence, the edge computing device may recognize which performance data to analyze and what the performance criteria should be for given devices. For example, the artificial intelligence may include a neural network that receives settings, firmware versions, configurations, performance testing, and the like, as inputs. Training data for the neural network may include settings, configurations, performance, and the like labeled as good or bad, and weights of performance features. The neural network may generate as an output a confidence level that a server is a good server based on whether the selected settings, configurations, versions, and the like are indicative of a good performance or a bad performance. Because a user may add a server directly to a network backbone (e.g., backbone routers directly connected to the Internet) with selected settings and configurations that may be available for selection implementation, but may be undesirable for actual operation, the neural network may need to determine which data to monitor and which criteria to use to assess good performance, and may determine for a newly built server a confidence level that the newly built server will perform well. When the confidence level is low for a server (e.g., below a threshold value), the edge computing device may follow up with a user to notify the user that the newly built server likely will not perform well due to certain settings, configurations, or the like, that have been selected for the server. The edge computing device also may determine whether a user has returned a server and when as an indication of poor performance.

In one or more embodiments, while the edge computing device does not need to ask a user which data to monitor for a newly built server, the edge computing device may allow for manual tests to be performed.

When an operating system is deployed (e.g., on a newly built server), many settings may change. For example, multiple sets of operating systems may be available for implementation in the edge computing environment. In one or more embodiments, the edge computing device may determine how and why settings change relative to baselines (e.g., existing topologies and templates). The edge computing device may test against existing equipment and/or new topologies to detect settings changes and their root causes.

In one or more embodiments, the collection and posting of baseline node data may be automated. To ingest the data from a newly built server connected directly to backbone routers, the server may run scrips to send the data to a central collection point. The neural network may compare the ingested data to old/gold baseline data to look for drift. When the neural network detects changes between systems, the neural network may look for correlations across other systems (e.g., to determine whether a change was expected and/or to identify the cause of a change). When the neural network detects drift, the neural network may generate an alarm for unexpected change or when the cause of the change is not identified. The neural network may implement data changes as a new gold baseline for evaluation criteria in some situations.

In one or more embodiments, when a user wants to provision a bare metal server through the edge cloud, the user may select one of multiple available operating systems, settings, and configurations tailored to the user's needs. However, the selected operating system, settings, and configuration may not perform well with certain hardware, software, or firmware. The neural network may predict, with the confidence score, whether a newly provisioned server will perform well based on the operating system, settings, and configuration selected.

The above descriptions are for purposes of illustration and are not meant to be limiting. Numerous other examples, configurations, processes, etc., may exist, some of which are described in greater detail below. Example embodiments will now be described with reference to the accompanying figures.

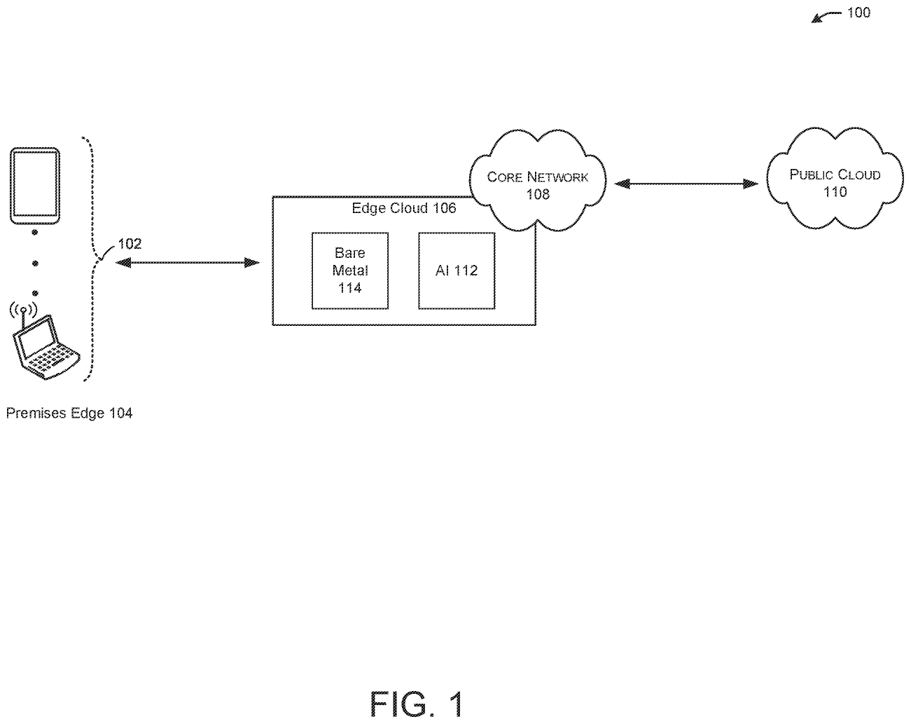

FIG. 1 illustrates an exemplary network environment 100 for edge computing in accordance with one embodiment.

Referring to FIG. 1, the network environment 100 may include client devices 102 at a customer premises edge 104 connecting to an edge cloud 106. Using a core network 108, the edge cloud 106 may connect the client devices 102 to a public cloud 110 (e.g., the Internet, cloud providers, etc.). The edge cloud may include artificial intelligence (AI) 112 for evaluating settings, configurations, and performance of bare metal servers 114 provisioned as bare metal as-a-service servers using the edge cloud 106. In general, the edge cloud 106 provides an example of an edge site of a network or collection of networks from which compute services may be provided to customers (e.g., the client devices 102) connected or otherwise in communication with the edge cloud 106. By providing the edge cloud 106, compute services may be provided to customers with a smaller latency than if the compute environment were included deeper within the network or further away from the requesting customer for the compute services.

To provision one of the bare metal servers 114, a user may provide a name for the server, select an operating system for the server, select a version of the operating system, select a physical location of the server, select a required server size (e.g., configuration), select CPU, a number of cores, and memory, add Internet Protocol addresses for the server, and select a network for the server. As a result, the server is provisioned automatically for the user (e.g., as opposed to the server physically being sent to the user to set up connections and configure). Example server configurations may include 4 cores E3/16 GB RAM/2×1 TB 7200 RAID 1 (0.91 TB usable), 12 cores E5/64 GB RAM/4×2 TB 7200 RAID 5 (5.46 TB usable), 20 cores E5/128 GB RAM/6×2 TB 7200 RAID 5 (9.09 TB usable), and others, depending on the location/data center.

In one or more embodiments, the AI 112 may receive all settings, configuration, and performance data of a bare metal server 114, and may be trained to predict whether the bare metal server 114 will meet performance criteria. For example, not all network settings selected for the bare metal server 114 may work well with the selected hardware, software, and/or firmware of the bare metal server 114.

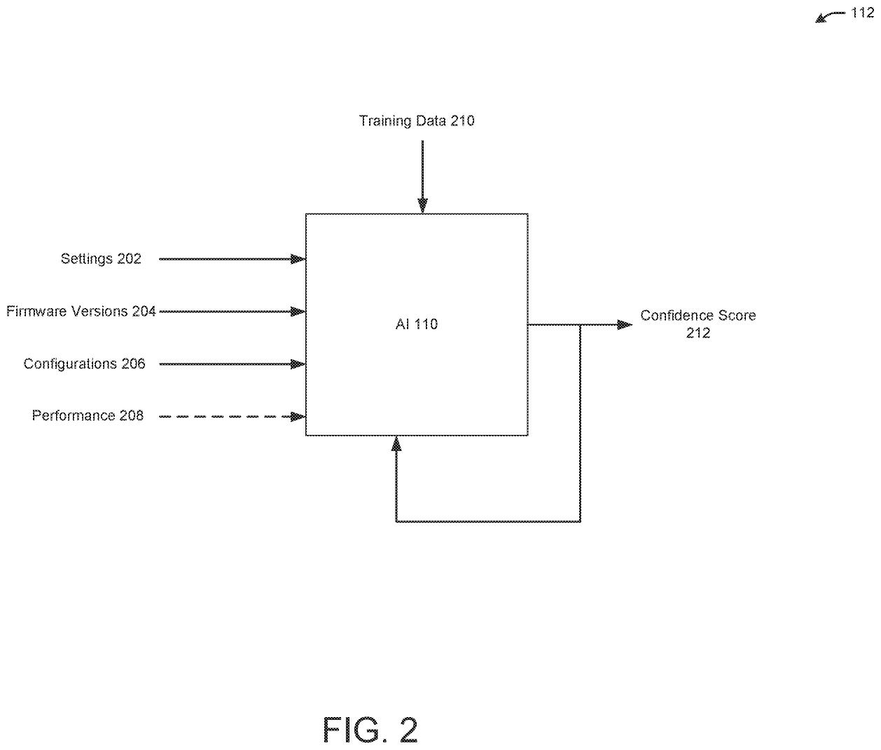

FIG. 2 is a schematic diagram of the artificial intelligence 112 of FIG. 1 used to test servers used in edge computing in accordance with one embodiment.

Referring to FIG. 2, the artificial intelligence 112 may receive as inputs settings 202, firmware versions 204, configurations 206, and (optionally) performance data 208 from the bare metal server 114 of FIG. 1 for analysis of the bare metal server 114. The artificial intelligence 112 may be trained using training data 210 that may include settings and performance data labeled as good or bad so that the artificial intelligence 112 (e.g., a neural network) may recognize whether the inputs are indicative of a strong or weak performance of the bare metal server 114.

In one or more embodiments, the training data 210 may be generated by testing other devices and topologies to determine which combinations of settings and configurations for hardware and software perform well and which do not. The inputs received from the bare metal server 114 may include all settings, configuration, and performance data (e.g., rather than a subset of data that the artificial intelligence 112 may request for analysis against pre-set criteria). The artificial intelligence 112 may learn which criteria (e.g., subset of the inputs) to analyze, and which weights to apply to the inputs (e.g., indicating which inputs are more or less likely to indicate a strong or poor performance).

In one or more embodiments, based on the inputs and the training data 210, the artificial intelligence 112 may generate a confidence score 212 for a bare metal server whose inputs are analyzed. The confidence score 212 may be indicative of a probability that a bare metal server will perform well. When the confidence score 212 is below a score threshold, the edge cloud 106 may notify a user of the bare metal server of the poor performance, and/or may disable or change a setting or configuration identified as the cause of the poor performance. The artificial intelligence 112 may compare the inputs to expected criteria (e.g., thresholds) and may detect drift. The drift may be expected (e.g., based on similar performance of other devices/topologies using the same settings/configurations) or unexpected. The edge cloud 106 may notify a user of the bare metal server of drift and whether the drift is unexpected or expected.

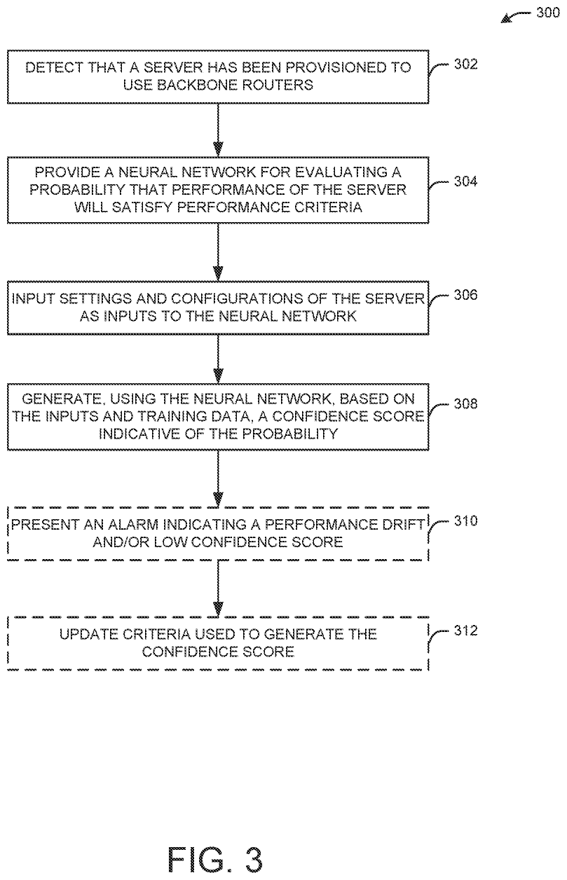

FIG. 3 is a flowchart illustrating a process 300 for testing servers used in edge computing in accordance with one embodiment.

At block 302, a device (or system, e.g., the edge cloud 106 of FIG. 1) may detect that a server (e.g., of the bare metal servers 114 of FIG. 1) has been provisioned to use backbone routers (e.g., of the core network 108 of FIG. 1) of the device to access the Internet and/or other resources (e.g., cloud-based resources). The provisioning of the server may include a selection of a network, operating system, operating system version, hardware, and other settings and configurations with which to deploy the server.

At block 304, the device may provide a neural network (e.g., the artificial intelligence 112 of FIG. 1) to analyze data of the provisioned server to detect whether the server will perform well (e.g., based on learned criteria and training data).

At block 306, the device may input the server settings and configuration data to the neural network.

At block 308, the device may use the neural network to generate a confidence score for the server based on the training data and the inputs. The neural network may learn which criteria to analyze, how much to weight the settings and configuration in the analysis, and whether the settings and configuration data are likely to result in a strong or poor performance (e.g., based on comparisons to learned criteria thresholds and training data indicating combinations of settings, configurations, hardware, and software that have been tested for performance). The confidence score may indicate a probability that the server will perform well.

At block 310, optionally, the device may present an alarm to a user of the server when the confidence score is below a threshold score and/or a performance drift (e.g., from expected performance criteria).

At block 312, optionally, the device may continue to use the neural network to learn and update its criteria used to generate the confidence score based on the confidence score and/or human review of the server implementation and its performance.

It is understood that the above descriptions are for purposes of illustration and are not meant to be limiting.

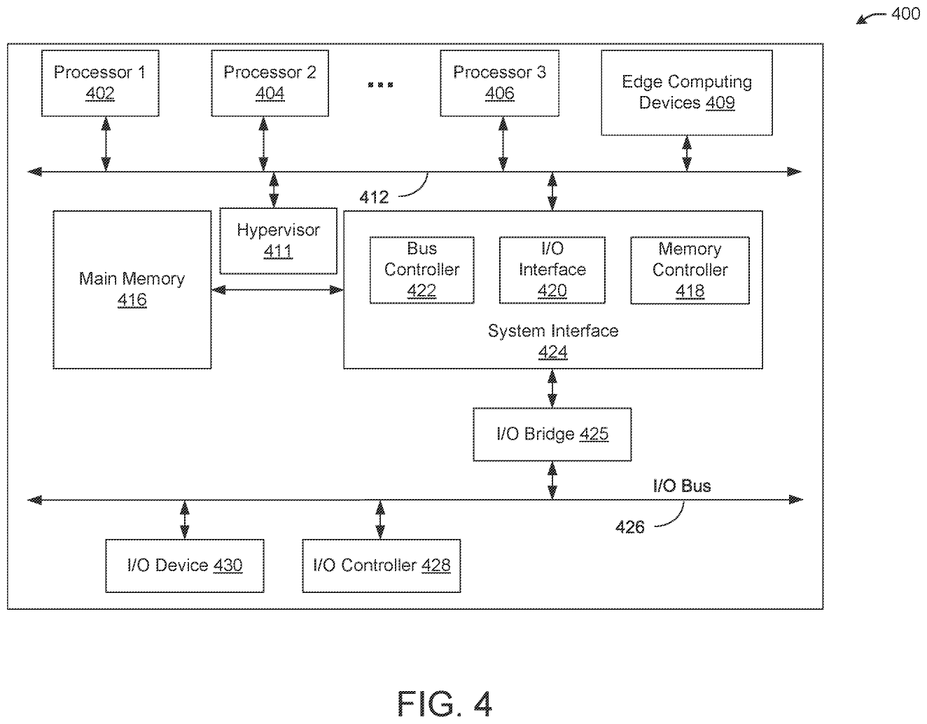

FIG. 4 is a block diagram illustrating an example of a computing device or computer system 400 which may be used in implementing the embodiments of the components of the network disclosed above. For example, the computing system 400 of FIG. 4 may represent at least a portion of the network environment 100 shown in FIG. 1 and discussed above. The computer system (system) includes one or more processors 402-406, one or more edge computing devices 409 (e.g., of the edge cloud 106 of FIG. 1), and a hypervisor 411 (e.g., to instantiate and run virtual machines, such as virtual network functions and bare metal servers). Processors 402-406 may include one or more internal levels of cache (not shown) and a bus controller 422 or bus interface unit to direct interaction with the processor bus 412. Processor bus 412, also known as the host bus or the front side bus, may be used to couple the processors 402-406 with the system interface 424. System interface 424 may be connected to the processor bus 412 to interface other components of the system 400 with the processor bus 412. For example, system interface 424 may include a memory controller 418 for interfacing a main memory 416 with the processor bus 412. The main memory 416 typically includes one or more memory cards and a control circuit (not shown). System interface 424 may also include an input/output (I/O) interface 420 to interface one or more I/O bridges 425 or I/O devices with the processor bus 412. One or more I/O controllers and/or I/O devices may be connected with the I/O bus 426, such as I/O controller 428 and I/O device 430, as illustrated.

I/O device 430 may also include an input device (not shown), such as an alphanumeric input device, including alphanumeric and other keys for communicating information and/or command selections to the processors 402-406. Another type of user input device includes cursor control, such as a mouse, a trackball, or cursor direction keys for communicating direction information and command selections to the processors 402-406 and for controlling cursor movement on the display device.

System 400 may include a dynamic storage device, referred to as main memory 416, or a random access memory (RAM) or other computer-readable devices coupled to the processor bus 412 for storing information and instructions to be executed by the processors 402-406. Main memory 416 also may be used for storing temporary variables or other intermediate information during execution of instructions by the processors 402-506. System 400 may include a read only memory (ROM) and/or other static storage device coupled to the processor bus 412 for storing static information and instructions for the processors 402-406. The system outlined in FIG. 4 is but one possible example of a computer system that may employ or be configured in accordance with aspects of the present disclosure.

According to one embodiment, the above techniques may be performed by computer system 400 in response to processor 404 executing one or more sequences of one or more instructions contained in main memory 416. These instructions may be read into main memory 416 from another machine-readable medium, such as a storage device. Execution of the sequences of instructions contained in main memory 416 may cause processors 402-406 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 406 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 416, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed:

1. A method for testing servers provisioned in an edge computing device, the method comprising:
detecting, by at least one processor of an edge computing device, that a server has been provisioned to access a public network cloud using backbone routers of the edge computing device;
providing, by the at least one processor, a neural network for evaluating a probability that a performance of the server will satisfy performance criteria, the neural network trained based on training data comprising labeled settings data and feature weights;
inputting, by the at least one processor, settings and configurations associated with the provisioning of the server as inputs to the neural network; and
generating, by the at least one processor, using the neural network, based on the inputs and the training data, a confidence score indicative of the probability.

2. The method of claim 1, wherein the settings and the configurations comprise all settings and configurations selected for the server for the provisioning of the server.

3. The method of claim 2, further comprising:
determining, using the neural network, a subset of the settings and the configurations to monitor for the server.

4. The method of claim 3, wherein determining the subset occurs without user selection of the subset.

5. The method of claim 1, further comprising:
determining that the confidence score is below a threshold score; and
presenting an indication to a user that the confidence score is below the threshold score.

6. The method of claim 1, further comprising:
detecting a drift of the settings or the computing network device compared to threshold performance criteria;
determining, based on a comparison of the settings and the configurations to an existing network topology implemented using the edge computing network device, a cause of the drift.

7. The method of claim 1, further comprising:
presenting, to a user, an indication of the cause of the drift.

8. The method of claim 1, further comprising:
updating, based on the confidence score, criteria with which the neural network is to generate the confidence score.

9. A system for testing servers provisioned in an edge computing device, the system comprising:
at least one processor of the edge computing device coupled to memory of the edge computing device, wherein the at least one processor is configured to:
detect that a server has been provisioned to access a public network cloud using backbone routers of the edge computing device;
provide a neural network for evaluating a probability that a performance of the server will satisfy performance criteria, the neural network trained based on training data comprising labeled settings data and feature weights;
input settings and configurations associated with the provisioning of the server as inputs to the neural network; and
generate, using the neural network, based on the inputs and the training data, a confidence score indicative of the probability.

10. The system of claim 9, wherein the settings and the configurations comprise all settings and configurations selected for the server for the provisioning of the server.

11. The system of claim 10, wherein the at least one processor is further configured to:
determine, using the neural network, a subset of the settings and the configurations to monitor for the server.

12. The system of claim 11, wherein to determine the subset occurs without user selection of the subset.

13. The system of claim 9, wherein the at least one processor is further configured to:
determine that the confidence score is below a threshold score; and
present an indication to a user that the confidence score is below the threshold score.

14. The system of claim 9, wherein the at least one processor is further configured to:
detect a drift of the settings or the computing network device compared to threshold performance criteria;
determine, based on a comparison of the settings and the configurations to an existing network topology implemented using the edge computing network device, a cause of the drift.

15. The system of claim 9, wherein the at least one processor is further configured to:
present, to a user, an indication of the cause of the drift.

16. The system of claim 9, wherein the at least one processor is further configured to:
update, based on the confidence score, criteria with which the neural network is to generate the confidence score.

17. A device for testing servers provisioned in an edge computing device, the device comprising at least one processor coupled to memory, the at least one processor configured to:
detect that a server has been provisioned to access a public network cloud using backbone routers of the edge computing device;
provide a neural network for evaluating a probability that a performance of the server will satisfy performance criteria, the neural network trained based on training data comprising labeled settings data and feature weights;
input settings and configurations associated with the provisioning of the server as inputs to the neural network; and
generate, using the neural network, based on the inputs and the training data, a confidence score indicative of the probability.

18. The device of claim 17, wherein the settings and the configurations comprise all settings and configurations selected for the server for the provisioning of the server.

19. The system of claim 18, wherein the at least one processor is further configured to:
determine, using the neural network, a subset of the settings and the configurations to monitor for the server.

20. The system of claim 19, wherein to determine the subset occurs without user selection of the subset.
